(19) United States
(12) Patent Application Publication
(10) Pub. No.: US 2018/0268488 A1
(43) Pub. Date: Sep. 20, 2018

(54) VIRTUAL DATABASE FOR VARIOUS INSURANCE PLANS

(71) Applicant: JAMES HERBERT STEVENOT, WAYCROSS, GA (US)

(72) Inventor: JAMES HERBERT STEVENOT, WAYCROSS, GA (US)

(21) Appl. No.: 15/460,248

(22) Filed: Mar. 16, 2017

(51) Int. Cl. G06Q 40/08; G06Q 40/00

(52) U.S. Cl. CPC G06Q 40/08; G06Q 40/12

(57) ABSTRACT

The present invention relates to a computationally implemented method designed to solve the complex problems related to accessing accurate, organized and current insurance policy information of a subject or client by a service provider or user, such as a clinician, and to record services or treatments rendered to maintain accurate reporting as well as request reimbursement from the insurance agency(s) of the subject or client for treatments or services covered by the associated insurance policy.

### FIELD OF THE INVENTION

The present invention relates to a computationally implemented method designed to solve the complex problems related to gaining knowledge of the coverage of at least one selected insurance policy to determine the best course of treatment or service to be administered to at least one patient or client, and further to record and survey insurance related actions.

### BACKGROUND OF THE INVENTION

Conventionally, the process of verifying health insurance, issuing the best care that the patient can afford, and petitioning the insurance company for payment is a time consuming and convoluted process. Each insurance company has their own private records; many patients and/or clients do not know or understand the details of their insurance policies, wherein the insurance cards do not provide all the relevant information to health professionals to know what treatments are covered under the patient's plan. The process of verifying the patient's plan involves contacting the insurance company and diverting labor to do so, which can result in being put on hold or not receiving the needed answers which causes further delay and loss of operational efficiency within a clinic. Also, the payment process is slow and can take nearly two weeks or more for payment to be delivered by the insurance company after treatment has been rendered.

Moreover, the user also faces problems when keeping track of these insurance policies, for example the time when it will mature or the various payment related details to be made by the at least one user for his/her policy or any associated service provider. Various insurance policy software and systems have been designed however that do not give full access to the user for his/her insurance account & also the user is not able to view or the various terms and perks related to their insurance policies.

Therefore, there remains a need to overcome above mentioned problems and our invention resolves these problems.

### SUMMARY OF THE INVENTION

The given computationally implemented method herein, has several iterations, each designed for optimum use by professionals in various insurance related industries. The core use of the computationally implemented method and the content creation for the same is performed by agents of insurance companies themselves. The computationally implemented method is used to assign, review, track and edit insurance policies purchased by the at least one user. In addition, the computationally implemented method is also enabled to be used by third party service providers to review current information of the at least one user's insurance policy, to deliver the most appropriate service and/or prescription for the at least one user per the at least one user's needs, budget, and insurance coverage.

The computationally implemented method may include insurance plans like but not limited to: health insurance, dental insurance, vision insurance, auto insurance, home insurance, renters' insurance, life insurance, liability insurance and the service/care providers. The providers that could benefit from use of the computationally implemented method are: hospitals, health clinics, dental offices, optometry offices, surgical centers, chiropractic practices, holistic health professionals, masseuses, law enforcement, attorneys, funeral home directors, auto repair garages, home repair contractors, mental health professionals and psychiatric institutions.

### BRIEF DESCRIPTION OF THE DRAWINGS

The following drawings illustrates an exemplary embodiment; however, they are helpful in illustrating objects, features and advantages of the present invention because the present invention will be more apparent from the following detailed description taken in conjunction with accompanying drawings in which:

FIG. 1 illustrates the flow chart view of the given invention per an embodiment of the invention.

### DETAIL DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further computationally implemented methods of the principles of the invention as illustrated therein being contemplated as would normally occur to one skilled in the art to which the invention relates.

References to “one embodiment,” “at least one embodiment(s),” “an embodiment,” “one example,” “an example,” “for example,” and so on indicate that the embodiment(s) or example(s) may include feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computationally implemented methods mentioned herein are incorporated herein in their entirety.

The given computationally implemented method herein, has several iterations, each designed for optimum use by professionals and the end user. The core data usage of the computationally implemented method and the content creation for the same is derived by agents of the insurance companies themselves. The computationally implemented method is used to assign, review, track and edit the at least one selected policy for the at least one client or patient. In addition, the computationally implemented method is also enabled to be used by third party service providers to review current information of the at least one user's insurance policy to deliver the most appropriate service for the at least one user according to the at least one user's needs, budget, and policy coverage and further request payment from insurance agencies for completed services. In yet another embodiment, the computationally implemented method, which may require paid access, is used by the client or patient to view the details of their insurance policy which may include the limits of their coverage and usage limits.

The computationally implemented method herein, is enabled to streamline the varied functions or tasks related to the at least one user's selected policy. The computationally implemented method herein, is enabled to operate on any user's smart device or computer. The service/care provider accesses the computationally implemented method from a separate computationally implemented method module which may be designed specifically for their industry or for general information. The service/care provider is able to make a request of the at least one user to access the at least one user's account, wherein with the at least one user's permission the service/care provider is enabled to review the at least one user's insurance coverage and the various services/care covered by their insurance policy.

The level of detailed information about the patient/user's policies may be restricted in nature, requiring a paid subscription or other form of payment to the developer of the computationally implemented method, by the service provider to access higher functions of the computationally implemented method. The information contained in a more basic level of functionality for service providers may include data about the patient/user's coverage such as; whether the patient is eligible for services offered by the service provider, whether the user/patient has a co-pay and if so what monetary amount(s) for what services, what the patient's deductible is and any variables on said deductible such as how much of the deductible has been met. The computationally implemented method may also include a search feature as well as a list of optional plans in addition to a primary insurance plan, such as dental, hearing, clinical surgical, or psych. A further level of functionality may include more detailed information about the patient/user's insurance coverage pertaining to specific medical procedures or treatments. This information may include whether that procedure, service, or drug is covered in the user's geographical location. For example, some procedures may be covered in one state, but not another. Further a drug formulary may be detailed in yet another function of the invention for service providers in which a searchable list of prescription drugs is made available with indication of which drugs are covered by the patient/user's insurance and to what extent. Drugs and other medications which are not covered by the insurance plan may contain under their listings within the computationally implemented method, alternative medications which may be prescribed in substitution which are covered in part or completely by the insurance plan of the patient/user. The current iteration of computationally implemented method is intended for medical insurance but may be expanded to include all types of insurance plans and the associated industries. Service/care providers that are benefited from use of the computationally implemented method are: hospitals, health clinics, dental offices, optometry offices, surgical centers, chiropractic practices, holistic health professionals, masseuses, law enforcement, attorneys, funeral home directors, auto repair garages, home repair contractors, mental health professionals, psychiatric institutions or the combination thereof.

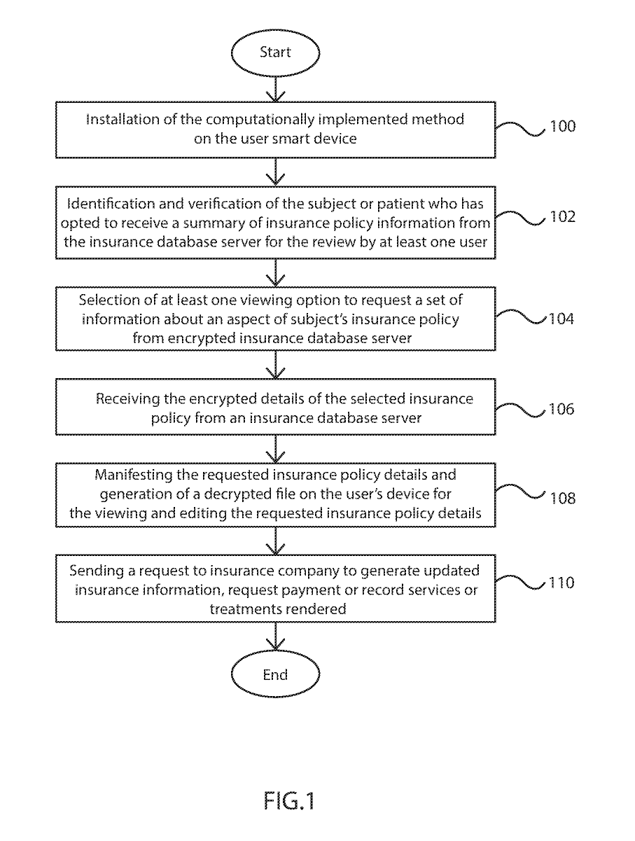

FIG. 1 illustrates the flow chart view of the given invention as per an embodiment of the given invention.

Step. 1 of FIG. 100 illustrates installation of the computationally implemented method on the at least one user's computational device wherein, the process of installation takes place via physical media or a digital platform such as a website or virtual store where a license and program data to use the computationally implemented method can be downloaded.

Step. 102 of FIG. 1 illustrates the process of identification and verification of the at least one user's identity who has requested access or given permission for a third party to access the user's at least one insurance policy. Once, the computationally implemented method has been installed on the at least one user's computational device, the at least one user is directed to the verification process, wherein the verification process enables the at least one user of the computationally implemented method to make proper and certified use of the computationally implemented method and further enables him/her to access the privacy status of the computationally implemented method on his/her computational device. The verification and permissions process carried out by the computationally implemented method is a digital process which may include electronic signature, PIN code, ID proof details of the at least one user or is a biometric verification process of the at least one user including thumb impression, retina scan or the combination thereof.

Step. 104 of FIG. 1 illustrates selecting at least one detail view from a plurality of viewing options of the policy(s) owned by the at least one subject which the at least one user requires to render appropriate service and treatment. The viewing options available to the user may be limited by the software license purchased from the provider of the computational method and its permissions. The viewing options each containing detailed information about at least one aspect of an insurance policy, such as types of coverage (dental, vision, medical, etc.) and items and/or treatments that qualify for insurance coverage, such as surgical treatments, specialist treatments, prescription drugs etc.

Step. 106 of FIG. 1 illustrates receiving details of the selected at least one insurance policy from a server, wherein the server processes a request for insurance policy information submitted by the user pertaining to a subject's policy. The server herein provides an encryption of the at least one verified subject's selected insurance policies that is to be accessed remotely by the at least one user and further generate a file for the selected insurance policy information, wherein the file information herein is categorized by the at least one subject's name and social security number, and is additionally to be catalogued by the at least one user's policy number, address, or other identifying data. Access to these files is restricted from those who lack the proper verification data for the file they are attempting to access, in accordance with HIPAA requirements. Also, the encryption of the file generated from the policy(s) acts to prevent loss or unauthorized access to sensitive information.

Step. 108 of FIG. 1 illustrates manifesting the requested insurance policy information and generation of a decrypted file on the at least one user's computational device for review and recording of services and treatments rendered. Herein once the computationally implemented method receives an encrypted file for the selected at least one subject's policy the computationally implemented method further displays decrypted information of the encrypted file on the at least one user's device wherein, the at least one user can access the various details and perks associated with the at least one subject's insurance policy. The computationally implemented method herein further enables the at least one user to review plan options, account history, and data input from third parties depending on the selected detail view requested. This enables easy access to relevant information to make sales, manage accounts, manage payments and communicate account details to other staff, the client or subject, caretakers, third party service providers. Also, the updating module enables the at least one user to see accurate and current information about the client's/patient's policy quickly and further enables the staff members to work more efficiently and have more time available to tend to the services to be rendered, rather than tending to tracking insurance information and payments.

Step. 110 of FIG. 1 illustrates sending a record of services and/or treatments rendered by the user to the insurance policy database via encrypted file, wherein the record enables updating the manifested details and generating a request for payment from the subject's insurance agency, to update log of payments made or required by the subject or patient and record a treatment plan or service.

The computationally implemented method is designed with specific features to best represent and receive relevant data for specific service interactions. While the invention has been described in detail with specific reference to preferred embodiments thereof, it is understood that variations and modifications thereof may be made without departing from the true spirit and scope of the invention.

What is claimed is:

1- A computationally implemented method enabled to operate on at least one user's device to provide policy details of at least one insurance policy of at least one subject, wherein the computationally implemented method comprises the steps of:
a. submitting account information of a subject to request permission to access insurance policy information from encrypted insurance database;
b. Requesting a selected insurance policy detail from a server, wherein the server processes the detail request and further encrypts and sends the detail information to the user;
c. manifesting the requested various insurance policy details and generation of a decrypted file on the at least one user's computational device; and
d. sending a record to the insurance policy database, wherein the record enables registering a log of services and/or treatments rendered and updating the manifested details and generating a request to receive payment from the subject or patient's insurance agency.

2- The computationally implemented method in claim 1; wherein the at least one policy includes at least one of a health insurance, a dental insurance, a vision insurance, an auto insurance, a home insurance, a renter insurance, a life insurance, a liability insurance, a service/care provider or the combination thereof.

3- The computationally implemented method in claim 1; wherein various providers that are to be benefited from a use of the computationally implemented method are at least one of a hospital, a health clinic, a dental office, a optometry office, a surgical center, a chiropractic practice, a holistic health professional, a masseuse, a law enforcement, an attorney, a funeral home director, an auto repair garage, a home repair contractor, a mental health professional and a psychiatric institution.

4- The computationally implemented method in claim 1; wherein the computationally implemented method enables an easy access of all relevant information relating to at least one policy of the at least one user to make sales, manage accounts, manage payments and communicate account details to other staff, a client, a care taker, a third party service provider or the combination thereof.

5- The computationally implemented method in claim 1; wherein the computationally implemented method provides automated tracking of the at least one insurance policy and various payments to be made by the at least insurance agency.

6- The computationally implemented method in claim 1; wherein the computationally implemented method is used to assign, review, track and edit the at least one selected insurance policy by the insurance agency.

7- The computationally implemented method in claim 1; wherein the encrypted file is categorized by the at least one subject's name, social security number and is also catalogued by the at least one subject's policy number, address or combination thereof.

8- The computationally implemented method in claim 1; wherein the computationally implemented method enables the third party service provider to review current information of the at least one subject's insurance policy, in order to deliver the most appropriate service for the at least one subject according to the at least one subject's needs, budget, and policy coverage.
